(19) United States
(12) Patent Application Publication
(10) Pub. No.: US 2010/0164709 A1
(43) Pub. Date: Jul. 1, 2010

(54) APPARATUS FOR MONITORING WATER DRINKING DEVICE

(76) Inventor: Yung-Chih LIN, Taipei City (TW)

Correspondence Address: Muncy, Geissler, Olds & Lowe, PLLC, 4000 Legato Road, Suite 310, FAIRFAX, VA, 22033, US

(21) Appl. No.: 12/344,960

(22) Filed: Dec. 29, 2008

(51) Int. Cl. G08C 17/02

(52) U.S. Cl. 340/539.1

(57) ABSTRACT

An apparatus for monitoring a water drinking device is provided. The apparatus includes a signal processing unit, at least a sensing unit provided in the water drinking device and electrically connected to the signal processing unit, and a wireless transmission unit electrically connected to the signal processing unit. The apparatus monitors the operation of the water drinking device in real time, and informs a user of a failure of the water drinking device in advance or in real time.

### BACKGROUND OF THE INVENTION

1. Field of the Invention

The present invention relates to apparatuses for monitoring a water drinking device, and more particularly, to an apparatus which comprises a wireless transmission unit and a sensing unit so as to monitor a water drinking device.

2. Description of the Prior Art

Drinking water nowadays is available in kitchens, at shops, with water drinking devices, etc. Water drinking devices are becoming more popular at home, and in public especially. The purpose of existing water drinking devices is to eliminate germs and impurities from water, and seldom are they designed to monitor their operation. As a result, a deteriorating water drinking device usually remains unattended until the advent of the destined failure, and belated maintenance brings inconvenience to users.

Hence, there is a need to develop an apparatus for monitoring a water drinking device, allowing the apparatus to monitor the operation of the water drinking device in real time and inform a user of a failure of the water drinking device in advance or in real time.

### SUMMARY OF THE INVENTION

In view of the shortcomings of the conventional water drinking devices, the inventor of the present invention believes that there is room for improvement in the conventional water drinking devices and finally succeeded, based on years of practical experience and after conducting pertinent research and experiments, in developing an apparatus for monitoring a water drinking device, allowing the apparatus to monitor the operation of the water drinking device in real time and inform a user of a failure of the water drinking device in advance or in real time.

To overcome the aforesaid drawbacks of the prior art, it is a primary objective of the present invention to provide an apparatus for monitoring a water drinking device, wherein the apparatus comprises a wireless transmission unit and a sensing unit, allowing the apparatus to monitor the operation of the water drinking device in real time, and inform a user of a failure of the water drinking device in advance or in real time.

To achieve the above and other objectives, the present invention provides an apparatus for monitoring a water drinking device. The apparatus comprises a signal processing unit, at least a sensing unit provided in the water drinking device and electrically connected to the signal processing unit, and a wireless transmission unit electrically connected to the signal processing unit.

The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit.

Furthermore, the sensing unit is a manometer, a thermometer, a flowmeter, a photometer, or an arbitrary combination thereof. The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit.

Furthermore, the sensing unit is a manometer, a thermometer, a flowmeter, a photometer, or an arbitrary combination thereof. The wireless transmission unit transmits signals by means of Wireless Fidelity (Wi-Fi), General Packet Radio Service (GPRS), 3rd Generation of Mobile Phone (3G), or High-Speed Downlink Packet Access (HSDPA). The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit.

The apparatus for monitoring a water drinking device of the present invention further comprises an alert unit electrically connected to the signal processing unit.

Furthermore, the sensing unit is a manometer, a thermometer, a flowmeter, a photometer, or an arbitrary combination thereof. The apparatus for monitoring a water drinking device of the present invention further comprises an alert unit electrically connected to the signal processing unit.

Furthermore, the sensing unit is a manometer, a thermometer, a flowmeter, a photometer, or an arbitrary combination thereof. The wireless transmission unit transmits signals by means of Wireless Fidelity (Wi-Fi), General Packet Radio Service (GPRS), 3rd Generation of Mobile Phone (3G), or High-Speed Downlink Packet Access (HSDPA). The apparatus for monitoring a water drinking device of the present invention further comprises an alert unit electrically connected to the signal processing unit.

The apparatus for monitoring a water drinking device of the present invention further comprises an alert unit electrically connected to the signal processing unit. The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit and the alert unit.

Furthermore, the sensing unit is a manometer, a thermometer, a flowmeter, a photometer, or an arbitrary combination thereof. The apparatus for monitoring a water drinking device of the present invention further comprises an alert unit electrically connected to the signal processing unit. The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit and the alert unit.

Furthermore, the sensing unit is a manometer, a thermometer, a flowmeter, a photometer, or an arbitrary combination thereof. The wireless transmission unit transmits signals by means of Wireless Fidelity (Wi-Fi), General Packet Radio Service (GPRS), 3rd Generation of Mobile Phone (3G), or High-Speed Downlink Packet Access (HSDPA). The apparatus for monitoring a water drinking device of the present invention further comprises an alert unit electrically connected to the signal processing unit. The signal processing unit comprises a signal input portion, a central processing portion, and a signal output portion. The sensing unit is electrically connected to the signal input portion. The signal input portion is electrically connected to the central processing portion. The central processing portion is electrically connected to the signal output portion. The signal output portion is electrically connected to the wireless transmission unit and the alert unit.

Accordingly, an apparatus for monitoring a water drinking device of the present invention monitors the operation of the water drinking device in real time, and informs a user of a failure of the water drinking device in advance or in real time.

### BRIEF DESCRIPTION OF THE DRAWING

FIG. 1 is a schematic view of a preferred embodiment of the present invention.

### DETAILED DESCRIPTION OF THE EMBODIMENT

The present invention is herein illustrated with a preferred embodiment in conjunction with the accompanying drawings, so that one skilled in the pertinent art can easily understand other objectives, features, advantages and effects of the present invention from the disclosure of the invention.

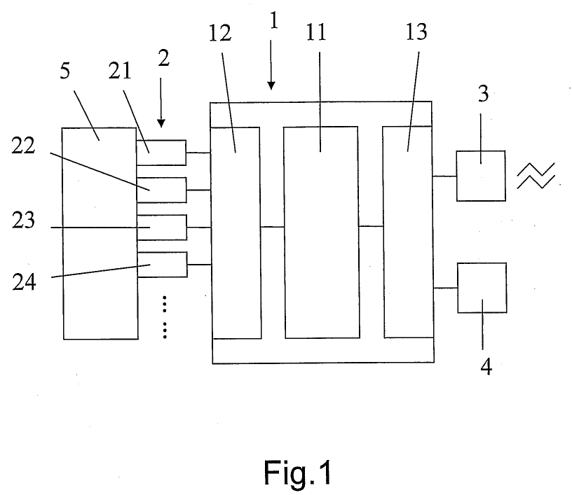

Referring to FIG. 1, which is a schematic view of a preferred embodiment of the present invention, the present invention provides an apparatus for monitoring a water drinking device, comprising a signal processing unit 1, at least a sensing unit 2, and a wireless transmission unit 3. The sensing unit 2 is provided in the water drinking device 5 and electrically connected to the signal processing unit 1. The wireless transmission unit 3 is electrically connected to the signal processing unit 1.

The sensing unit 2 is a manometer 21, a thermometer 22, a flowmeter 23, a photometer 24, or an arbitrary combination thereof. The manometer 21 senses whether the pressure in a pipeline of the water drinking device 5 is normal. The thermometer 22 senses whether the water temperature of the water drinking device 5 is normal. The flowmeter 23 senses whether the flow in a pipeline of the water drinking device 5 is normal. The photometer 24 senses whether a photocatalyst fiber processor (not shown) of the water drinking device 5 is functioning well. The wireless transmission unit 3 transmits signals by means of Wireless Fidelity (Wi-Fi), General Packet Radio Service (GPRS), 3rd Generation of Mobile Phone (3G), or High-Speed Downlink Packet Access (HSDPA), i.e., 3.5G.

Furthermore, the signal processing unit 1 comprises a signal input portion 12, a central processing portion 11, and a signal output portion 13. The sensing unit 2 is electrically connected to the signal input portion 12. The signal input portion 12 is electrically connected to the central processing portion 11. The central processing portion 11 is electrically connected to the signal output portion 13. The signal output portion 13 is electrically connected to the wireless transmission unit 3. The sensing unit 2 is a manometer 21, a thermometer 22, a flowmeter 23, a photometer 24, or an arbitrary combination thereof. The wireless transmission unit 3 transmits signals by means of Wireless Fidelity (Wi-Fi), General Packet Radio Service (GPRS), 3rd Generation of Mobile Phone (3G), or High-Speed Downlink Packet Access (HSDPA).

The apparatus further comprises an alert unit 4 electrically connected to the signal processing unit 1. The alert unit 4 alerts a user by voice, an alert sound, a luminous body, or an arbitrary combination thereof. The sensing unit 2 is a manometer 21, a thermometer 22, a flowmeter 23, a photometer 24, or an arbitrary combination thereof. The wireless transmission unit 3 transmits signals by means of Wireless Fidelity (Wi-Fi), General Packet Radio Service (GPRS), 3rd Generation of Mobile Phone (3G), or High-Speed Downlink Packet Access (HSDPA). The signal processing unit 1 comprises a signal input portion 12, a central processing portion 11, and a signal output portion 13. The sensing unit 2 is electrically connected to the signal input portion 12. The signal input portion 12 is electrically connected to the central processing portion 11. The central processing portion 11 is electrically connected to the signal output portion 13. The signal output portion 13 is electrically connected to the wireless transmission unit 3 and the alert unit 4.

In practice, the sensing unit 2 monitors the water drinking device 5. For instance, the pressure in a pipeline of the water drinking device 5 is sensed by the manometer 21, the water temperature of the water drinking device 5 is sensed by the thermometer 22, the flow in a pipeline of the water drinking device 5 is sensed by a flowmeter 23, and the operation of a photocatalyst fiber processor of the water drinking device 5 is sensed by the photometer 24. In a situation where a failure of the water drinking device 5 is likely to happen soon, for example, the water drinking device 5 is disadvantaged by increased pressure in a pipeline thereof and decreased flow in the pipeline due to impurities accumulated after long service, abnormal water temperature of a deteriorating heating or cooling element of the water drinking device 5, abnormal flow in the pipeline due to a deteriorating pump (not shown) of the water drinking device 5, or abnormal luminosity due to a deteriorating UV tube (not shown) of the photocatalyst fiber processor, the signals sensed by the sensing unit 2 are transmitted to the signal input portion 12 of the signal processing unit 1, and then to the central processing portion 11 of the signal processing unit 1. Upon determination, by the central processing portion 11, that some of the signals are above or below a predetermined normal value, the central processing portion 11 generates failure signals corresponding to the failure. The failure signals generated are sent to the signal output portion 13 of the signal processing unit 1 and then to the wireless transmission unit 3 so as to request maintenance personnel at the remote end to come to fix the water drinking device 5. Alternatively, the failure signals are further sent to the alert unit 4 to ask a user at the local end to cope with the failure.

In the situation where the water drinking device 5 fails unexpectedly, the apparatus of the present invention also follows the above procedure to ask the maintenance personnel to come to fix the water drinking device 5. Furthermore, the apparatus of the present invention can be connected to a server at the remote end via the wireless transmission unit 3, so as to record and monitor various signals of the water drinking device 5 in real time.

Hence, the present invention meets the three patentability criteria, namely novelty, an inventive step, and industrial applicability. Regarding novelty and an inventive step, the apparatus of the present invention monitors the operation of the water drinking device in real time, and informs a user of a failure of the water drinking device in advance or in real time, by means of a wireless transmission unit and a sensing unit. Regarding industrial applicability, any products derived from the present invention should be capable of meeting the current market needs.

The aforesaid specific embodiment is only illustrative of the features and functions of the present invention but is not intended to restrict the scope of the present invention. It is apparent to those skilled in the art that all equivalent modifications and changes made in the aforesaid embodiment according to the spirit and principle in the disclosure of the present invention should fall within the scope of the present invention. Accordingly, the scope of the present invention should be defined with the appended claims.

What is claimed is:

1. An apparatus for monitoring a water drinking device, comprising:
a signal processing unit;
at least a sensing unit provided in the water drinking device and electrically connected to the signal processing unit; and
a wireless transmission unit electrically connected to the signal processing unit.

2. The apparatus of claim 1, wherein the sensing unit is one selected from the group consisting of a manometer, a thermometer, a flowmeter, a photometer, and an arbitrary combination thereof.

3. The apparatus of claim 2, wherein the wireless transmission unit transmits signals by one selected from the group consisting of Wireless Fidelity (Wi-Fi), General Packet Radio Service (GPRS), 3rd Generation of Mobile Phone (3G), and High-Speed Downlink Packet Access (HSDPA).

4. The apparatus of one of claims 1, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit.

5. The apparatus of one of claims 2, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit.

6. The apparatus of one of claims 3, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit.

7. The apparatus of claim 1, further comprising an alert unit electrically connected to the signal processing unit.

8. The apparatus of claim 2, further comprising an alert unit electrically connected to the signal processing unit.

9. The apparatus of claim 3, further comprising an alert unit electrically connected to the signal processing unit.

10. The apparatus of one of claims 7, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit and the alert unit.

11. The apparatus of one of claims 8, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit and the alert unit.

12. The apparatus of one of claims 9, wherein the signal processing unit comprises a signal input portion, a central processing portion, and a signal output portion, the sensing unit being electrically connected to the signal input portion, the signal input portion being electrically connected to the central processing portion, the central processing portion being electrically connected to the signal output portion, and the signal output portion being electrically connected to the wireless transmission unit and the alert unit.
